(19) United States
(12) Patent Application Publication
(10) Pub. No.: US 2026/0168578 A1
(43) Pub. Date: Jun. 18, 2026

(54) SLIDE RING OF A MECHANICAL SEAL, AND METHOD FOR THE PRODUCTION THEREOF

(71) Applicant: EagleBurgmann Germany GmbH & Co. KG, Wolfratshausen (DE)

(72) Inventors: Stefanie Kreft, München (DE); Robert Suszniak, Münsing (DE)

(73) Assignee: EagleBurgmann Germany GmbH & Co. KG, Wolfratshausen (DE)

(21) Appl. No.: 19/129,164

(22) PCT Filed: Nov. 13, 2023
(86) PCT No.: PCT/EP2023/081588

§ 371 Date: May 12, 2025

(30) Foreign Application Priority Data
Nov. 24, 2022 (DE) 10 2022 131 103.1

(51) Int. Cl. F16J 15/34

(52) U.S. Cl. CPC F16J 15/3436

(57) ABSTRACT

The invention relates to a slide ring of a mechanical seal arrangement, comprising a sintered, ceramic ring (41) having a sliding surface (4a) which is produced from an electrically non-conductive ceramic material, and an electrically conductive contact body (42) which is configured for electrical contacting and is arranged in a recess (40) in the ring (41), wherein the electrically conductive contact body (42) comprises a first region (42a) and a second region (42b), wherein the first region (42a) is arranged in the recess (40) at an end of the recess (40) directed towards the sliding surface (4a) and fills a part of the recess (40), and wherein the second region (42b) fills the rest of the remaining recess (40), wherein the first region (42a) is produced from a first, electrically conductive, ceramic material of a first hardness, and wherein the second region (42b) is produced from a second electrically conductive material of a second hardness, and wherein the first hardness of the first region (42a) is greater than the second hardness of the second region (42b).

The present invention relates to a slide ring of a mechanical seal, a mechanical seal arrangement, and a method for producing the slide ring.

Slide rings of mechanical seal arrangements are known in various embodiments from the prior art. In recent times, sensor means for monitoring a slide ring, for example its wear, are increasingly arranged on a sliding surface of the slide ring. In this case, a problem area emerges such that the sensor means located on the sliding surface have to be electrically contacted. Since the sensor means are located on the sliding surface, it is necessary for electrical through-contacting through the slide ring to take place. Since a very brittle ceramic is often used as the material for the slide ring, drilled holes or the like, which have to be made in the slide ring in order to allow for electrical contacting, are dangerous in particular in that they can result in the risk of invisible damage and cracks in the slide ring. Furthermore, slide rings are often coated on their sliding surfaces, for example with a diamond coating. Here, however, drilled holes in the slide ring which extend as far as the sliding surface, even if these are filled with a material, are very disadvantageous since peeling of the coating often occurs at the edges of the drilled holes. Since a coating is typically produced as the last step during the production of the slide ring, for example in the case of a diamond coating very high process temperatures of up to 900° C. also arise. This results in problems relating to thermal technology, for electrical contacting, for low-melting metals that may possibly be present in the slide ring, since the melting points of such metals are significantly below the coating temperatures.

It must furthermore be ensured that, in the case of the drilled hole for electrical contacting which reaches as far as the sliding surface, no increased crack formation occurs either at the edges of the drilled hole or in a material arranged in the drilled hole. It is furthermore also necessary for simple and reliable electrical contacting of the material filling the drilled hole to be possible.

The object of the present invention is therefore that of providing a slide ring, a mechanical seal arrangement, and a method for producing a slide ring, which allow for reliable electrical contacting of sensor means on a sliding surface of the slide ring while having a simple design and being simple and cost-effective to produce and implement. This object is achieved by a slide ring having the features of claim 1, a mechanical seal arrangement having the features of claim 14, and a method having the features of claim 15. The dependent claims in each case disclose preferred developments of the invention.

The slide ring according to the invention, of a mechanical seal arrangement, having the features of claim 1, has the advantage, in contrast, that simplified and more reliable electrical contacting through the slide ring to the sliding surface is possible. As a result, in particular sensors which are arranged on or close to a sliding surface of the slide ring or in the slide ring can be electrically contacted. However, it is for example also possible for an electrical circuit to be guided through the slide ring, which circuit can be used for example for measuring wear, if the electrical circuit is arranged such that in the event of wear on the sliding surface of the slide ring the electrical circuit is broken when the wear has progressed to a corresponding extent. In this case, the slide ring can be produced from an electrically non-conductive, ceramic material, which is advantageous with respect to suitability as a slide ring material. This is achieved according to the invention in that the slide ring comprises a sintered, ceramic ring having a sliding surface, wherein the ceramic ring is produced from an electrically non-conductive ceramic material. Furthermore, an electrically conductive contact body is provided, which is arranged, for electrical contacting, in the ring. In this case, the electrically conductive contact body is arranged in a recess in the ring, e.g. a recess similar to a drilled hole, and fills the recess completely. The electrically conductive contact body comprises a first and a second region, wherein the first region is arranged in the recess at an end of the recess directed towards the sliding surface and the second region fills the remaining recess. The second region is thus arranged in the recess on a side of the slide ring directed towards the rear side. The first and second region are in each case produced from an electrically conductive material, wherein a first electrically conductive material of the first region has a greater hardness than a second electrically conductive material of the second region. Thus, the first electrically conductive material of greater hardness lies on the side directed towards the sliding surface. As a result, crack formation on the sliding surface, which frequently occurs, in the prior art, at the edge of the recess or in the electrically conductive material of the contact body, can be prevented. In this case, the first region is produced from an electrically conductive, ceramic material. The second region of the electrically conductive contact body, which faces away from the sliding surface, is produced from an electrically conductive material and can therefore be optimised, at its output side out of the slide ring, for excellent electrical contacting with a wire or the like for a connection to a power source and/or an evaluation unit or the like.

Since the first region is made of a ceramic material, which preferably has similar thermal expansion behaviour to the material of the ceramic ring, the slide ring produced in this way nonetheless has excellent slide ring properties and allows for a wide field of application with respect to maximum pressures and maximum temperatures.

In this way, a ceramic slide ring can be provided which, due to the introduction of the electrically conductive contact body, is electrically conductive only in the region of the electrically conductive contact body. Since both the ring and the first region of the contact body are produced from a ceramic material, significant advantages in operation result for example compared with a slide ring in which exclusively a metal material is arranged as the electrical line, since the heat occurring at the sliding surface during operation of the mechanical seal arrangement leads, in the case of the slide ring according to the invention, to a very uniform, temperature-related volume change at the sliding surface.

Particularly preferably, the first region of the electrically conductive contact body is produced from electrically conductive SiSiC. This is a reaction-bonded, silicon-infiltrated SiC, wherein this material has a very significant hardness. The sintered ceramic ring is preferably produced from SiC and thus has a virtually identical thermal expansion behaviour to the SiSiC material. The second region is preferably a composite material comprising silicon and SiC. In this case, in particular the metal silicon provides the electrical conductivity of the second region of the electrically conductive contact body. As a result, electrical contacting by means of a wire or the like can take place in a simple manner at an exposed end in the recess of the material of the second region of the electrically conductive contact body. The electrical contacting is preferably established by a welded connection or soldered connection or electrical gluing. Alternatively, a metal pin or a metal sleeve or the like can also be provided for electrical contacting, in or on the second region.

The second region is thus preferably metal silicon which is reinforced with an admixed SiC fraction. Preferably, a volume fraction of the metal silicon is greater than a volume fraction of the SiC. Preferably, the volume fraction of the metal silicon is 63 vol. %- 72 vol. % and the volume fraction of the SiC is 18 vol. %- 27 vol. %. Further preferably, the second region comprises gas-filled pores, wherein a volume fraction of the gas-filled pores is between 5 vol. %- 15 vol. %.

In this case, the admixed SiC of the second region ensures that atomic bonds are formed between the second region and the ceramic ring. As a result, a uniform volume change occurs in the case of temperature-related volume changes of the ring with the electrically conductive contact body. The second region is thus preferably produced from a mixture of metal silicon and SiC with optionally a small volume fraction of gas-filled pores.

Further preferably, the first region is of a first length L1 in the axial direction of the recess which is smaller than a second length L2 of the second region in the axial direction of the recess. In this case, the first length L1 is preferably very much smaller than the second length L2. The first length L1 is preferably in a range of 1 mm to 2 mm. Particularly preferably, in this case, the second length L2 is greater than the first length L1 by at least a factor of 10.

Further preferably, the first region of the electrically conductive contact body is connected to a sensor arranged on the sliding surface. The sensor preferably comprises an electrically conductive sensor layer made from the same material as the first region of the electrically conductive contact body. As a result, the sensor and the first region can be produced in a common step. Particularly preferably, in this case, the sensor layer is arranged in a depression in the sliding surface of the slide ring.

Alternatively, the sensor is an electrically conductive sensor layer which is arranged on the entire sliding surface of the slide ring.

Further preferably, the sensor is covered by a coating as a protective layer. The coating is preferably an electrically non-conductive layer, for example undoped DLC. Coated slide rings are preferably used, since the coating on the sliding surface of the slide ring makes it possible to extend a service life of the slide ring by reduced wear. A problem area in the case of a coating of a sliding surface of a slide ring, however, is that typically very high process temperatures, for example in the case of a diamond coating up to 900° C., are necessary for this. However, metals which are provided in a slide ring for electrical contacting melt at such high temperatures of approximately 900° C. As a result, however, it has hitherto not been possible to provide coated slide rings with a sensor, in particular a wear sensor, since electrical contacting of the sensor by means of the typical contacting methods is not possible. However, a retrospective introduction of electrical contacting, for example providing a drilled hole in the ceramic ring after applying the coating, is very difficult and costly, and there is always the risk that the ceramic slide ring may experience cracks or the coating damage, as a result of which a reject fraction in the production of such coated ceramic slide rings having electrical lines is very high, and is generally uneconomic.

Particularly preferably, a plurality of chemical bonds produced by sintering are formed between the electrically conductive contact body and the ring. This ensures on the one hand reliable fixing of the contact body in the ring, and on the other hand thermally-related volume changes of the ring and of the contact body are performed in a particularly uniform manner as a result. In this case it is noted that at least portions of the contact body and the ring can be sintered together in one step, or alternatively the ring is pre-sintered and subsequently the materials for the first and second region of the contact body are introduced into the recess and then in a second sintering step the pre-sintered ring and the materials for the first and/or second region of the contact body are resintered.

The recess in the ring is preferably a through-hole recess. In this case, the through-hole recess can extend from a rear side to the sliding surface, in particular in a straight line, or alternatively can extend from an inner peripheral side or an outer peripheral side to the sliding surface. This allows for electrical contacting of the slide ring at the peripheral sides, which is advantageous in some designs of mechanical seal arrangements.

Particularly preferably, the second region of the electrically conductive contact body forms an electrical connection, at the output side of the contact body, for the electrically conductive contact body, to which an electrical line can be attached in a simple manner, e.g. by soldering or welding.

Preferably, in this case, the slide ring is a stationary slide ring of the mechanical seal arrangement and comprises two electrically conductive contact bodies in the ring of the slide ring, in order to allow for electrical contacting of the sensor via a closed circuit. In this case, the first of the contact bodies is an electrical supply line, and the second of the contact bodies is an electrical return line.

The ceramic ring of the slide ring is preferably produced from SiC, which is an electrically non-conductive material, i.e. has an electrical conductivity of ≤10⁸S/m at 20° C.

The present invention furthermore relates to a mechanical seal arrangement comprising a slide ring according to the invention. The slide ring according to the invention is preferably used as a stationary slide ring of the mechanical seal arrangement. The mechanical seal arrangement particularly preferably comprises a sensor on the stationary slide ring, which sensor is electrically connected to a measuring instrument via the electrically conductive contact body. The sensor is in particular a wear sensor.

The present invention furthermore relates to a method having the features of claim 15 for producing a slide ring, in particular a stationary slide ring, of a mechanical seal arrangement. In this case, the method comprises the steps of:
producing an annular green body from an electrically non-conductive ceramic material,
introducing a through-hole recess in the green body,
pre-sintering the green body,
filling a first portion of the recess in the pre-sintered green body with a first electrically conductive, ceramic material, in particular SiSiC,
introducing a second electrically conductive material, in particular a composite material comprising metal silicon and SiC, into the remaining second portion of the recess, and
resintering the slide ring with the first and second electrically conductive material, in order to form a first region and a second region of an electrically conductive contact body in the recess, such that a ceramic slide ring is produced having an electrically non-conductive ceramic ring and the electrically conductive contact body, wherein a hardness of the first region is greater than a hardness of the second region.

The method according to the invention thus makes it possible for a ceramic slide ring of a mechanical seal arrangement to be produced which is electrically non-conductive but comprises an electrically conductive contact body through the sintered first and second electrically conductive material, i.e. here the material located in the recess. The slide ring can thus be obtained by sintering in two steps. Preferably, during resintering, at the same time a sensor material of a senor, in particular a wear sensor, is also sintered.

In this case, the advantages described above for the slide ring are achieved.

Preferably, after the two-fold sintering of the slide ring a coating, in particular a diamond coating, is applied to a sliding surface of the slide ring.

Preferred embodiments of the invention are described in detail in the following, with reference to the accompanying drawings, in which:

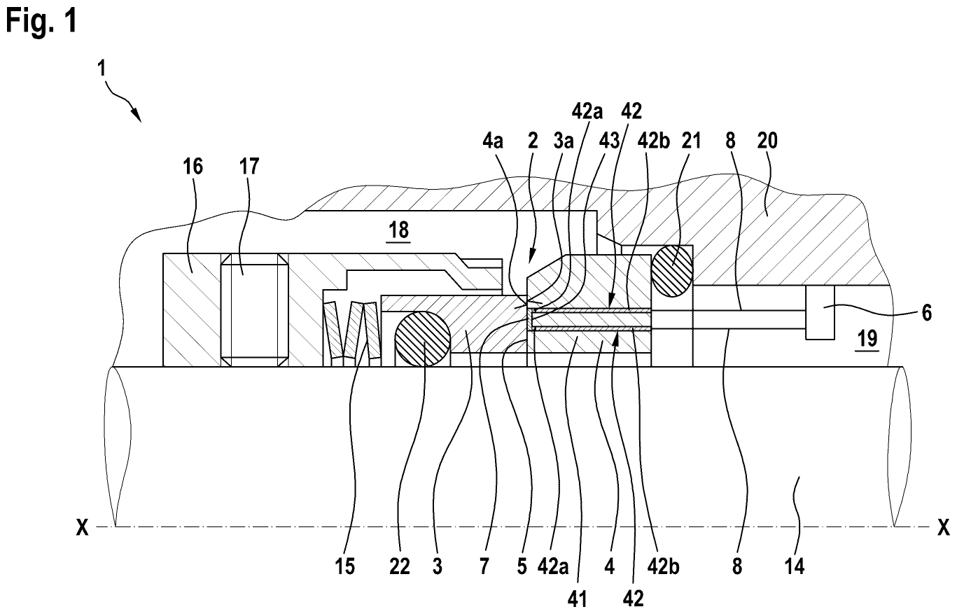

FIG. 1 is a schematic sectional view of a mechanical seal arrangement comprising a slide ring according to the invention, according to a first embodiment of the invention,

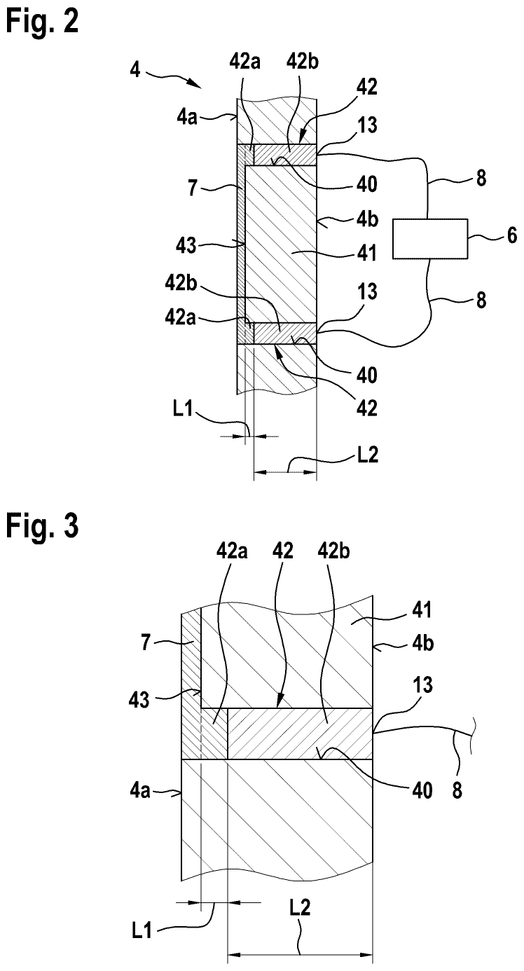

FIG. 2 is a schematic sectional view of the slide ring according to the invention from FIG. 1,

FIG. 3 is an enlarged view of FIG. 2,

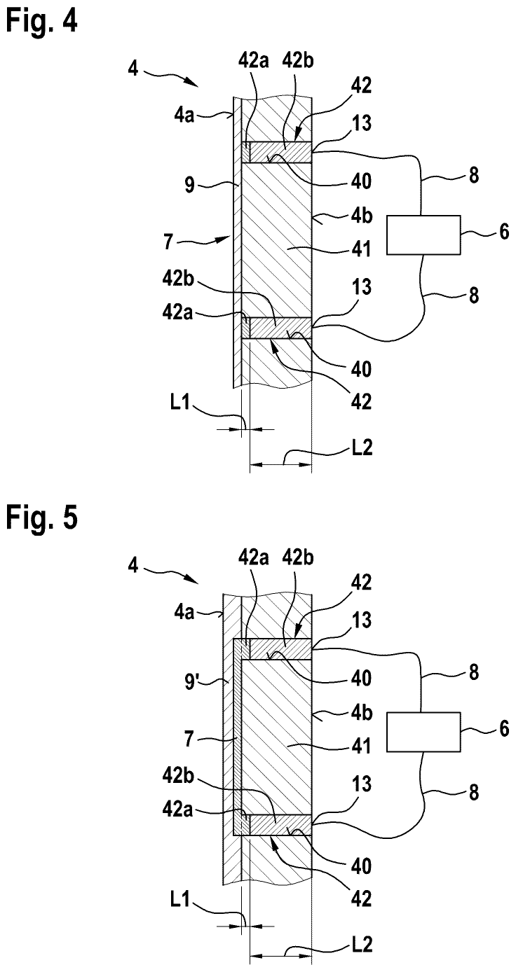

FIG. 4 is a schematic sectional view of a slide ring according to a second embodiment of the invention, and

FIG. 5 is a schematic sectional view of a slide ring according to a third embodiment of the invention.

A mechanical seal arrangement 1 according to a first preferred embodiment of the invention is described in detail in the following with reference to FIG. 1 to 3.

As can be seen from FIG. 1, the mechanical seal arrangement 1 comprises a mechanical seal 2 having a rotating slide ring 3 and a stationary slide ring 4. The rotating slide ring 3 comprises a first sliding surface 3a, and the stationary slide ring 4 comprises a second sliding surface 4a.

A sealing gap 5 is defined between the two sliding surfaces 3a, 4a of the slide rings 3, 4. In this case, the mechanical seal arrangement 1 seals a region 18 in which a product to be sealed is present, from an atmosphere region 19, at a shaft 14. In this case, the rotating slide ring 3 is non-rotatably connected to the shaft 14 by means of a slide ring carrier 16 and a screw 17.

Furthermore, a preload element 15 is provided which preloads the rotating slide ring 3 relative to the stationary slide ring 4 in an axial direction of a central axis X-X.

The stationary slide ring 4 is sealed relative to a stationary housing component 20 by means of a first O-ring 21. The rotating slide ring 3 is sealed at its inner periphery on the shaft 14 by means of a second O-ring 22.

The mechanical seal arrangement 1 further comprises a measuring instrument 6 which is configured in particular for measuring wear of the stationary slide ring 4 at its sliding surface 4a. In this case, the measuring instrument 6 is connected to a sensor 7. The sensor 7 is arranged on the sliding surface 4a of the stationary slide ring 4.

The sensor 7 is arranged in a depression 43 in the sliding surface and is preferably a wear sensor.

For this purpose, electrical contacting of the sensor 7 on the sliding surface 4a must be provided, which can be seen in detail from FIG. 2. As can be seen from FIG. 2, the stationary slide ring 4 comprises a sintered, ceramic ring 41 which is produced from an electrically non-conductive ceramic material, in particular SiC. Furthermore, two identically constructed electrically conductive contact bodies 42 are arranged in the ring 41, for contacting the sensor 7.

As can be seen from FIGS. 2 and 3, the electrically conductive contact bodies 42 extend from a rear side 4b to the sliding surface 4a. The electrically conductive contact bodies 42 are arranged in recesses 40, formed in the ring 41, and extend in a straight line and in parallel through the slide ring 4.

The electrically conductive contact body 42 comprises a first region 42a and a second region 42b.

The electrically conductive contact bodies 42 each comprise an electrical connection region 13, on an output side on the rear side 4b of the slide ring 4, for an electrical line 8. In this case, the electrical connection region 13 is formed such that the electrical line 8 can be connected directly to the second region 42b.

The first region 42a is arranged in the recess 40 at an end of the recess 40 directed towards the sliding surface 4a and contacts the sensor 7. The second region 42b fills the remaining recess 40 and extends as far as the rear side 4b of the stationary slide ring 4.

The first region 42a is produced from a first, electrically conductive, ceramic material and in this embodiment is produced from SiSiC. The second region is produced from a different, second electrically conductive material, and in this embodiment is produced from a mixture of metal silicon and SiC, in order to form a composite material. The composite material can comprise at most 15 vol. % gas-filled pores.

In this case, a hardness of the first electrically conductive ceramic material is greater than a hardness of the second electrically conductive material. A determination of the hardness of the first and second electrically conductive material can be ascertained using known methods, for example the Vickers method.

Crack formation at the sliding surface can be prevented by the harder first region 42a which is formed in the recess 40 on the side facing towards the sliding surface 4a. This relates both to cracks which can appear in the ceramic ring 41 due to the recess 40, i.e. at the edge of the recess 40, and cracks in the electrically conductive contact body 42 itself, which can also continue further into the ceramic ring 41 after being formed. The second region 42b of the electrically conductive contact body 42, which comprises the metal silicon and extends as far as the rear side 4b of the stationary slide ring 4, allows for direct and uncomplicated electrical contacting with the electrical line 8. In particular, no metal pins or the like have to be provided here in the electrically conductive contact body 42 for the electrical contacting. The electrical line 8 can be fixed directly, e.g. by means of screws.

Thus, the electrically conductive contact body 42 with the two different regions 42a and 42b on the sliding surface makes it possible to prevent crack formation and allows for simple, quick and cost-effective electrical contacting with the electrical line 8 on the rear side of the stationary slide ring 4.

As is furthermore visible from FIG. 2, in this embodiment the sensor 7 is produced from the same material as the first region 42a, specifically SiSiC. Thus, a production-related simple connection between the sensor 7 and the electrically conductive contact bodies 42 can be achieved. In particular, the sensor 7 is produced simultaneously with the first region 42a.

As can be seen in particular from FIG. 3, the first region 42a is of a first length L1 in the axial direction of the contact body 42 which is smaller than a second length L2 of the contact body 42 in the axial direction. The first length L1 is preferably in a range of 1 mm to 2 mm.

A thickness of the layer of the sensor 7 is again smaller than the first length L1.

As shown in FIG. 1, the two electrically conductive contact bodies 42 are electrically connected via the electrical lines 8 to the measuring instrument 6, and thus the sensor 7 is also electrically connected to the measuring instrument 6.

In this case, the stationary slide ring 4 made of ceramic material can be produced such that in a first step an annular green body is provided, in accordance with the desired geometric shape of the stationary slide ring 4, from an electrically non-conductive ceramic material, e.g. SiC. At the same time or subsequently, the recesses 40 for the electrically conductive contact bodies 42 are formed in the green body. Pre-sintering of the green body then takes place. Subsequently, the depression 43 is also introduced. In a next step, the depression 43 for the sensor 7 is filled and the recesses 40 are partially filled, wherein the same material, e.g. SiSiC, is used. In this case, the recesses 40 are only partially filled, until the first length L1 in the recess 40 is filled, in order to form the first region 42a. Subsequently, the second electrically conductive material, which forms the second region 42b, is introduced into the still free region in the recess 40. In this case, a mixture of metal silicon and a ceramic material, in particular SiC, can be introduced for the second region 42b. Subsequently, re-sintering of the slide ring takes place, such that the first and second region 42a, 42b are sintered with the sensor 7, wherein no SiSiC results in the second region 42b, but rather metal silicon and SiC are present as a mixture.

The resintering also results, in addition to the formation of SiSiC in the first region 42a, in chemical bonds between the material of the ring and the material of the second region 42b of the contact body 42.

Since a thermal expansion of the ceramic of the ring 41 and the two regions 42a, 42b of the electrically conductive contact body 42 is substantially the same, in particular no component weakening occurs in the case of thermal expansion, as would be present in the case of use of a metal material for electrical contacting. Furthermore, this likewise does not result in any temperature-dependent limitations in a selection of the coating 9. In particular, a diamond coating, which must be applied at temperatures of approximately 900° C., can be provided, which can be applied after production of the slide ring.

Furthermore, the atomic bonds during the step of resintering, between the material of the ring 41 and the material of the first region 42a of the electrically conductive contact body 42, result in flush terminations, in particular at the sliding surface, such that the slide ring has an excellent degree of evenness and in particular also an edge-less transition is present between the ring material and the material of the electrical contact region.

This also results in significantly improved emergency operating features, in particular with respect to a possible emergency operation duration, since, for example after wear of the sensor 7, there is nonetheless a flat surface present on the sliding surface 4a, in particular edge-free at the transition between the two materials, which can be used as a sliding surface for emergency operation.

Thus, a stationary slide ring 4 can be provided, which for example comprises a sensor 7 for wear measurement at the sliding surface. If the sensor 7 is ablated by wear, an electrical circuit across the contact bodies 42 is broken, which is an indicator of wear. In this case, the sensor contacting is integrated in the ring and ensured by the slippery, ceramic material. A particularly simple thermal electrical contacting by welding or soldering, directly on the slide ring, can also take place via the second region 42b, without damage to the slide ring occurring.

FIG. 4 shows a slide ring 4 of a mechanical seal arrangement according to a second embodiment of the invention. Identical or functionally identical parts are denoted by the same reference signs as in the first embodiment.

In contrast to the first embodiment, the slide ring of the second embodiment comprises a coating 9. The coating is applied over the entire sliding surface of the slide ring, and in this embodiment is an electrically conductive DLC coating. This can be achieved for example by means of a doped DLC coating. The electrically conductive coating 9 forms the sensor 7 and in this case closes the electrical circuit between the two contact bodies 42 in the ring 41. Should the coating 9 be worn, the electrical circuit is broken at the sliding surface, such that wear is displayed on the measuring instrument 6 due to the broken circuit. Otherwise, the embodiment corresponds to the previous embodiment, and therefore reference can be made to the description given there.

FIG. 5 shows a slide ring 4 according to a third embodiment of the invention. Identical or functionally identical parts are denoted by the same reference signs as in the previous embodiments.

As can be seen from FIG. 5, the third embodiment substantially corresponds to the first embodiment. However, in the third embodiment no depression is provided on the sliding surface of the ring 41. The sensor 7 is provided as an electrically conductive coating on a portion of the sliding surface of the ring 41. In this case, the sensor 7 electrically interconnects the two electrically conductive contact bodies 42 and closes the electrical circuit. An electrically non-conductive coating 9′ is formed over the sensor 7. The electrically non-conductive coating 9′ covers the entire sliding surface of the slide ring 4. The structure of the contact body 42 having the first region 42a and the second region 42b again corresponds to the preceding embodiments.

In the case of wear of the electrically non-conductive coating 9′ and the sensor 7, again the electrical circuit is electrically broken, such that the measuring instrument 6 can emit a corresponding wear signal. Otherwise, this embodiment corresponds to the preceding embodiments, and therefore reference can be made to the description given there.

In addition to the above written description of the invention, for the additional disclosure thereof reference is hereby explicitly made to the illustrative representation of the invention in FIG. 1 to 5.

### LIST OF REFERENCE SIGNS

1 mechanical seal arrangement
2 mechanical seal
3 rotating slide ring
3a first sliding surface
4 stationary slide ring
4a second sliding surface
4b rear side
5 sealing gap
6 measuring instrument
7 sensor
8 electrical line
9 electrically conductive coating
9′ electrically non-conductive coating
13 electrical connection
14 shaft
15 preload element
16 slide ring carrier
17 screw
18 region in which product to be sealed is present
19 atmosphere region
20 housing component
21 first O-ring
22 second O-ring
40 recess
41 electrically non-conductive ceramic ring
42 electrically conductive contact body
42a first region
42b second region
43 depression in the sliding surface
L1 first length
L2 second length
X-X central axis

1. Slide ring of a mechanical seal arrangement, comprising
a sintered, ceramic ring having a sliding surface which is produced from an electrically non-conductive ceramic material, and
an electrically conductive contact body which is configured for electrical contacting and is arranged in a recess in the ring,
wherein the electrically conductive contact body comprises a first region and a second region,
wherein the first region is arranged in the recess at an end of the recess directed towards the sliding surface and fills a part of the recess and,
wherein the second region fills the rest of the remaining recess,
wherein the first region is produced from a first, electrically conductive, ceramic material of a first hardness, and
wherein the second region is produced from a second electrically conductive material of a second hardness, and
wherein the first hardness of the first region is greater than the second hardness of the second region.

2. Slide ring according to claim 1, wherein the first region is produced from electrically conductive SiSiC.

3. Slide ring according to claim 1, wherein the second region is made of a composite material of metal silicon and SiC.

4. Slide ring according to claim 1, wherein the first region is of a first length (L1) in the axial direction of the recess which is smaller than a second length (L2) of the second region in the axial direction of the recess.

5. Slide ring according to claim 1, wherein the first region is connected to a sensor arranged on the sliding surface.

6. Slide ring according to claim 5, wherein the sensor is an electrically conductive sensor layer and is produced from the same material as the first region.

7. Slide ring according to claim 6, wherein the sensor layer is arranged in a depression in the sliding surface of the slide ring.

8. Slide ring according to claim 5, wherein the sensor is an electrically conductive coating arranged on the entire sliding surface.

9. Slide ring according to claim 5, wherein the sensor is covered by an electrically non-conductive coating which forms the sliding surface of the slide ring.

10. Slide ring according to claim 1, wherein chemical bonds produced by sintering are formed between the electrically conductive contact body and the ring.

11. Slide ring according to claim 1, wherein the recess is a through-hole recess which extends from a rear side to the sliding surface or which extends from an inner peripheral side or an outer peripheral side to the sliding surface.

12. Slide ring according to claim 1, wherein an electrical line with the electrically conductive contact body, is directly electrically connected to the second region.

13. Slide ring according to claim 1, wherein the slide ring is a stationary slide ring of the mechanical seal arrangement and two contact bodies are present in the ring for electrically contacting the sensor, in order to form an electrically closed circuit.

14. Mechanical seal arrangement comprising a stationary slide ring according to claim 1, and a measuring instrument which is electrically connected to the contact body of the slide ring.

15. Method for producing a slide ring, comprising the steps of:
producing an annular green body from an electrically non-conductive ceramic material,
introducing a through-hole recess in the green body,
pre-sintering the green body,
filling a portion of the recess with a first electrically conductive, ceramic material,
introducing a second electrically conductive material into the portion of the recess that is not yet filled, and
re-sintering the slide ring with the first and second electrically conductive material, in order to form a first region and a second region of an electrically conductive contact body in the recess, such that a ceramic slide ring is produced having an electrically non-conductive ceramic ring and the electrically conductive contact body, wherein a hardness of the first region is greater than a hardness of the second region.

16. Method according to claim 15, wherein a coating is applied to the sliding surface of the slide ring after the re-sintering, and/or wherein during the resintering a sensor material is also sintered.
